(19) United States
(12) Patent Application Publication
(10) Pub. No.: US 2003/0112430 A1
(43) Pub. Date: Jun. 19, 2003

(54) Method and device for optically inspecting bottles

(76) Inventor: Peter Lindner, Sunching (DE)

Correspondence Address: Richard B Hoffman, Marshall Gerstein & Borun, 233 S Wacker Drive Suite 6300, Sears Tower, Chicago, IL, 60606-6357, US

(21) Appl. No.: 10/220,882

(22) PCT Filed: Dec. 18, 2001
(86) PCT No.: PCT/EP01/14972

(30) Foreign Application Priority Data
Dec. 29, 2000 (DE) 100 65 290.5

(51) Int. Cl. G01N 21/00

(52) U.S. Cl. 356/239.4

(57) ABSTRACT

The invention pertains to a method and an apparatus for the optical inspection of bottles in an inspection station comprising at least one camera for recording images of a bottle or a bottle part and at least one lighting unit which illuminates at least one bottle or a bottle part. The apparatus and the method are characterized by the fact that several inspection steps are provided in a single inspection station, said steps following one another as closely as possible.

### DESCRIPTION

The invention pertains to a method and an apparatus for the optical inspection of bottles in an inspection station comprising at least one camera for recording images of a bottle or a bottle part and at least one lighting unit which illuminates at least one bottle or one bottle part.

When bottles are manufactured or recycled, they are inspected by means of optical inspection units. The term inspection station is to be understood here as a spatially separated unit in which inspection steps are performed on a bottle in a space that is as compact as possible. A machine for the inspection of bottles may contain several of such spatially separated inspection stations. The objective is to recognize bottles that are fractured, cracked, chipped, scuffed or dirty in order to eliminate them from further use. Scuffing means that the bottle body or the mouthpiece sealing surface is worn or chafed, which may be caused by friction of a bottle against another bottle, a bottle container, such as a beverage crate, or another object.

Of special interest in this context is the inspection of the bottle bottom for impurities as well as the inspection of the mouthpiece sealing surface for chips. Such defects of the mouthpiece sealing surface make it impossible to cap the bottle in a gas-tight manner by means of a crown cork or a screw cap, because the chip prevents the closure from being pressed against the mouthpiece sealing surface in a sealing manner.

A monitoring of chips in the area of the mouthpiece sealing surface is an important process step also with regard to possible injury hazards on account of sharp edges in the area of the chip.

In general, the various inspection steps, for example the inspection of the bottom of the bottle and/or of the mouthpiece sealing surface, are performed one after the other in various inspection units specially equipped for each individual step and separated spatially. The disadvantage of such an arrangement is that the resulting design for a complete bottle inspection is elaborate and requires a lot of space. It must be taken into consideration in this context that a fully equipped bottle inspection machine may feature a number of additional inspection stations for thread inspection, residual liquid recognition, side wall inspection, etc., which may result in a considerable overall length.

In order to circumvent these disadvantages, inspection methods are known in which two inspection steps are performed simultaneously. The bottom of the bottle is illuminated by means of a lamp, for example. By inserting a diaphragm and a camera arranged behind it, an image of the bottom of the bottle is recorded. A second camera, used with the aid of a beam splitter, is simultaneously recording an image of the mouthpiece sealing surface.

It is especially difficult to simultaneously inspect the outside and the inside of the mouthpiece sealing surface. An annular lighting unit is used for the inspection of the outside of the mouthpiece sealing surface. When inspecting the inside of the mouthpiece sealing surface, the bottle is illuminated from above in the direction of the mouthpiece sealing surface. Potential chips can only be recognized only with great difficulty, because the illumination of the mouthpiece sealing surface simultaneously from various directions produces an inadequate contrast.

It is therefore the task of the invention at hand to provide a method and an apparatus for the optical inspection of bottles which ensures a comprehensive inspection of a bottle without using spatially extended structures for this purpose.

This task is solved by means of an apparatus with the characteristics of claim 1 and a method with the characteristics of claim 14.

In the apparatus according to the invention, at least one lighting unit is used to illuminate a bottle or a part of a bottle, and at least one camera is used to record an image of a bottle or a part of a bottle. The installations for the inspection of the bottle are designed in such a fashion that some inspection steps, especially such that may interfere with one another, in particular because of the illumination involved, are performed at different points of time, but in such a fashion that these points of time follow one another as closely as possible. This makes it possible, in an advantageous fashion, to perform in direct succession several inspection steps which do not interfere with one another, but to accommodate these various inspection steps in a single, very compact inspection station.

In an advantageous manner, the inspection of a bottle, consisting of several inspection steps, is completed before the inspection of another bottle is started. This ensures a simple control of the mechanism intended to eliminate a defective bottle, because only one bottle is being inspected at any given time, and thus an unambiguous result classification is guaranteed.

In an advantageous manner, the apparatus for the optical inspection of bottles is designed in such a fashion that at least one camera is recording images of the mouthpiece sealing surface of a bottle. Images of the mouthpiece sealing surface are especially needed for the evaluation of the quality of the mouthpiece sealing surface.

A further development of the invention comprises at least one camera for recording images of the bottom of the same bottle. Even after washing, there may still be residual impurities or defects at the bottle bottom, especially in the case of recycled bottles. Such impurities or defects may be recognized with certainty by means of a camera recording images from the bottom of a bottle.

An advantageous further development of the invention comprises a lighting unit which illuminates the whole bottom of the bottle or a part of it. An illumination of the bottom of the bottle, especially a transillumination, ensures a certain detection of residual impurities on the bottom of the bottle. In addition, the illumination of the bottom of the bottle allows the inspection of other parts of the bottle than just the bottom. This is due to the fact that the wall of the bottle, if illuminated appropriately, acts as a light conductor and conducts the light from the bottom of the bottle to the mouthpiece sealing surface. Thus, by illuminating the bottom of the bottle, certain defects in the mouthpiece sealing surface of the bottle may be determined.

In an advantageous manner, the apparatus for the optical inspection of bottles is equipped with an annular lighting unit which illuminates the mouthpiece sealing surface, in particular the outer area of the mouthpiece sealing surface. The annular design of the lighting unit has the advantage that images of the mouthpiece sealing surface can be recorded through the center opening of the lighting unit with a camera, in particular from above. Such an annular lighting unit ensures a homogenous, uniform illumination of the outside of the mouthpiece sealing surface.

An advantageous further development of the invention comprises a lighting unit which illuminates the mouthpiece sealing surface essentially perpendicularly from above. The light from such a lighting unit may be directed perpendicularly to the mouthpiece sealing surface by means of a semitransparent mirror, for example. In particular, the illumination of the mouthpiece sealing surface from a perpendicular direction makes it possible to inspect the inside of the mouthpiece sealing surface. Chips or other defects, especially in the area of the inside of the mouthpiece sealing surface, are very difficult to determine by means of other methods.

An essential further development of the invention provides an installation for moving the bottles relative to the optical inspection units. The advantage of such an installation is that the bottles may be brought into the optical inspection unit, then guided past the various positions in which the various inspection steps are performed, and subsequently taken out of the inspection unit.

Advantageously, the installation for moving the bottles relative to the optical inspection apparatus is an installation equipped in such a manner that the bottles are moved through the optical inspection apparatus in a continuous fashion. This makes it possible to keep the design of the installation for moving bottles relatively simple. The design will be dependent on whether in addition to the inspection of the mouthpiece sealing surface, an inspection of the bottom is to be performed as well. For an inspection of the mouthpiece sealing surface, a simple conveyor belt supporting the bottles at the bottom may be sufficient, while an inspection of the bottle bottoms advantageously requires clamping belts or grabbing clamps holding the bottles at the sides.

In an advantageous further development of the invention, the apparatus for the optical inspection of bottles is designed in such a fashion that the light from two different illumination positions within the inspection unit falls on a single camera. This makes it possible to record images of various inspection steps or perspectives by means of one camera. The use of a single camera ensures a simpler design of the invention, which results, amongst other things, in a cost reduction. For this purpose, the invention advantageously uses a beam splitter, which directs the light from one of the various spatial positions to the camera, without entirely shutting down the beam coming to the camera from another inspection position.

A further advantageous possibility of performing various inspection steps in a cost-effective manner is to arrange a camera in such a fashion as to capture at least two different positions for two different inspection steps in the range of the camera. When the bottles are moving within the optical inspection unit, these two images, which are being recorded for such inspection steps, must be recorded as quickly one after the other as possible, so that the bottle does not leave the range of the camera prematurely because of its movement. Such an arrangement allows, in an advantageous manner, various inspections to be performed using a single camera, without any additional optical elements.

In a further advantageous embodiment of the invention, the apparatus for the optical inspection of bottles is provided with an annular lighting unit in such a manner that several inspection steps may be performed in succession through the annular opening of the lighting unit. This is possible both in the case of a single camera, which, for example, records multiple images through the annular opening, and in the case of using several cameras, which record images of the bottle through the annular opening. The design of the annular lighting unit is such that multiple inspection steps may be performed through its opening (for example, mouthpiece and bottom inspection). This allows for an especially compact design of the inspection station, which is a special advantage for the reasons mentioned above. If the bottles are moved through the optical inspection unit, this is an advantage especially in the case of such a design which allows the performance of various inspection steps at different points of time which, however, follow one another as quickly as possible.

In the method for the optical inspection of bottles according to the invention, the following steps are performed in succession. First, a bottle is brought into an optical inspection unit. Subsequently, at at least two different points of time, that however follow each other as closely as possible, various inspection steps of at least one bottle or one bottle part are performed in said inspection unit. Then the bottle is taken out of the inspection unit, in order to make room for the next bottle. Performing different inspection steps at different points of time has the advantage that the different inspection steps cannot influence one another. Each inspection step may be individually optimized with regard to contrast, light yield, etc. Performing the inspection steps at points of time following each other as closely as possible allows for a quick, comprehensive and certain evaluation of each bottle.

In the method for the optical inspection of bottles it is advantageous to fully complete the evaluation of one bottle by means of the optical inspection methods regarding its fitness for further use before starting the evaluation of the next bottle. The advantage consists in the fact that in this way it is sufficient to provide a single installation for eliminating a defective or dirty bottle. It is not necessary to follow a bottle as it passes various inspection stations.

In a particularly advantageous method, the mouthpiece sealing surface, or the inside and/or outside of the mouthpiece sealing surface is inspected.

Also advantageous are methods in which the bottom of the bottle is illuminated entirely or in part, the mouthpiece sealing surface is illuminated with an annular lighting unit, and the mouthpiece sealing surface is illuminated from a direction essentially perpendicular to its surface.

In an especially advantageous form of the method for the optical inspection of bottles, a bottle or a bottle part is illuminated by two different lighting units in succession. An illumination at different points of time has the advantage that in the case of defects of the bottle each illumination in itself creates an image with maximum contrast. It is further possible to design the lighting units in such a fashion and to arrange them along the path of the bottles with an offset and overlap, as to use very short light impulses, such as flashlights, which makes it possible to perform the various inspection steps in extremely close temporal succession.

In particular, this results in the advantage that two images of one and the same bottle or one and the same bottle part can be recorded with a single camera but with at least two different illuminations. The use of a single camera especially facilitates a very compact design of the inspection station. A further development of the method according to the invention is to record images of one and the same bottle with two cameras, whereby in each case the bottle is illuminated differently. Each camera may be directed towards the same or a different bottle part, recording images with maximum contrast due to the illumination being provided at different points of time.

It is especially advantageous in this context if two different inspection steps are performed within a time interval of no more than 50 milliseconds. This makes it possible to complete the inspection of a single bottle in a speedy fashion, before the inspection of the next bottle is started.

It is especially advantageous in this context if the bottles are moved relative to the optical inspection unit. If the various inspection steps are performed within 50 milliseconds, the bottles can travel through the optical inspection unit at a rate of several meters per second.

It is advantageous in this context if the bottles are moved through the optical inspection unit in a continuous fashion, because in such a case no braking or accelerating is necessary and high throughputs can be achieved.

An advantageous method in this context is one in which a single camera records images of one and the same bottle in positions which are spatially as close as possible to each other. Due to the fact that the two positions, in which the various inspection steps are performed, are relatively close to each other, it ispossible to arrange the camera in such a way that sharp images are recorded in both positions. This allows for a simple design of the optical detection. It is not necessary to move or adjust the camera to the various positions.

Below, the method according to the invention shall be explained through the discussion of two exemplified embodiments, with the aid of figures. The figures are showing:

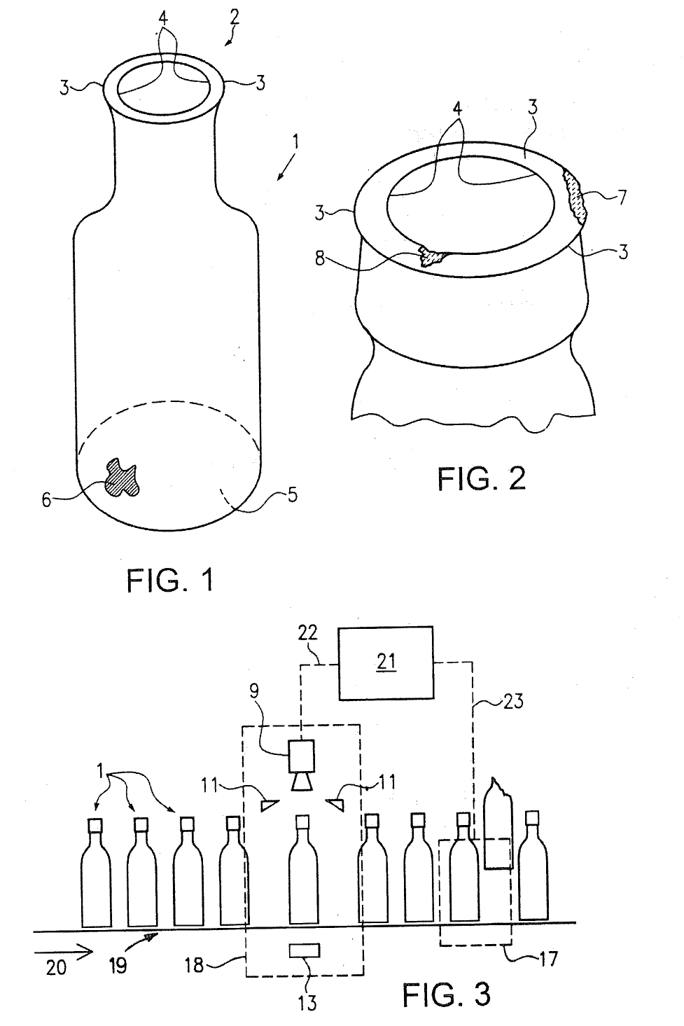

FIG. 1 a drawing of a bottle,

FIG. 2 an enlarged view of the mouthpiece sealing surface of a bottle,

FIG. 3 a lateral view of an optical inspection unit together with a transporter installation for bottles,

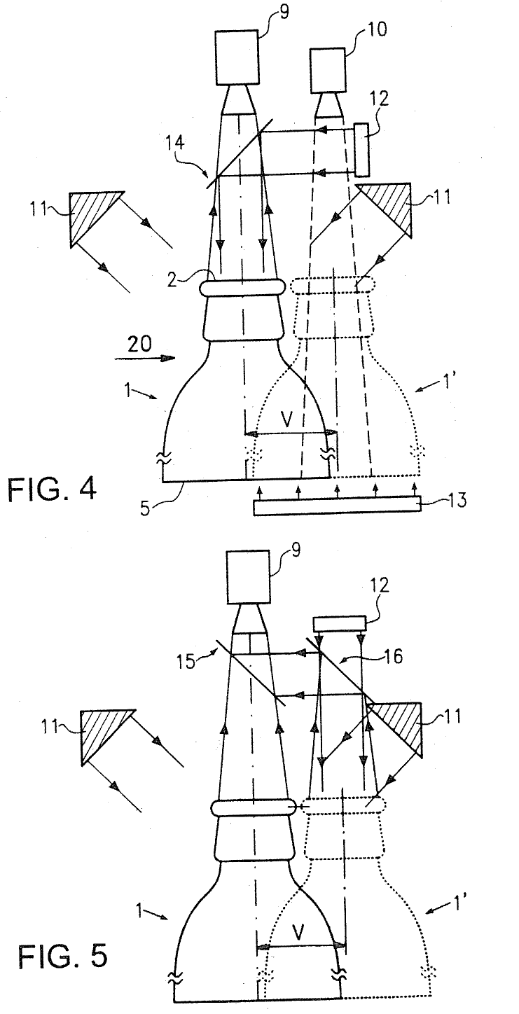

FIG. 4 a lateral view of the installations of an optical inspection unit according to the first exemplified embodiment, and

FIG. 5 a lateral view of the installations of an optical inspection unit according to the second exemplified embodiment.

FIG. 1 and FIG. 2 show a bottle 1 with a mouthpiece sealing surface 2 as well as with the outside of the mouthpiece sealing surface 3 and the inside of the mouthpiece sealing surface 4. An impurity 6 is shown on the bottle bottom 5. FIG. 2 shows a chip 7 on the outside of the mouthpiece sealing surface as well as a chip 8 on the inside of the mouthpiece sealing surface.

FIG. 3 shows, in a simplified fashion, an optical inspection unit 18, through which bottles 1 are moved on a transporter installation 19 in the direction 20. The transporter installation 19 may be designed as a translucent conveyor belt or an pair of elastic belts engaging the bottles laterally by friction (see DE29821826.7). In the optical inspection unit 18, images of the bottle 1 are recorded with the camera 9. The signals from the camera 9 are fed to an evaluation and control unit 21 via a signal line 22. The evaluation and control unit 21 evaluates the signals and controls, via a control line 23, an ejection station 17 which eliminates defective or dirty bottles. The optical inspection unit 18 features a CCD camera 9, an annular, centrally open lighting unit 11 for illuminating the mouthpiece sealing surface and a lighting unit 13 arranged below the bottle bottom, whereby in the embodiment according to FIG. 1 these elements are essentially arranged concentrically with regard to an imagined vertical axis. The lighting units 11 and 13 may consist of a number of LED's, for example.

FIG. 4 shows a possible embodiment of the apparatus. A bottle 1 is illuminated by means of an annular lighting unit 11 from above at an angle, in particular in the outer area of the mouthpiece sealing surface. A mouthpiece camera 9 records an image of the mouthpiece sealing surface 2. The image is recorded by means of camera 9, approximately centrally through the annular lighting unit 11. By means of a beam splitter 14, the light of another lighting unit 12 is guided in the direction of the mouthpiece sealing surface 2 perpendicularly from above. This allows for an inspection of the inside of the mouthpiece sealing surface by means of the camera 9. Laterally in the direction 20, offset by a distance V, the same bottle 1′ is shown in a different position. In this position, the transparent bottle bottom is illuminated by means of a lighting unit 13, which is also offset by a distance V, and an image of the bottle bottom is recorded by means of a bottom camera 10 (CCD camera). In the embodiment presented here, this too is performed through the opening of the annular lighting unit 11. The distance V may amount to a few centimeters or millimeters (FIG. 4), or only fractions of a millimeter (FIG. 3). In both positions, the inspected bottles 1 or 1′ are still just about entirely within the vertical projection of the lighting unit 11.

FIG. 5 shows a further embodiment of the apparatus according to the invention. Here, a lighting unit 12 is shown, which essentially illuminates the bottle 1′ from a direction perpendicular to the mouthpiece sealing surface, directly from above. The light originating from the mouthpiece sealing surface is directed to the mouthpiece camera 9 by means of a beam splitter 16 and another beam splitter 15. The mouthpiece camera 9 may further record an image of the bottle 1 through the beam splitter 15, whereby here the annular lighting unit 11 illuminates the outer part of the mouthpiece sealing surface. The bottles 1 and 1′ shown in the figure are one and the same bottle, which is being inspected in positions offset by the distance V. In this embodiment of the apparatus according to the invention, again two different images are recorded through the opening of the annular lighting unit 11, whereby the bottle, in particular its mouthpiece sealing surface, is just about entirely within the vertical projection of the lighting unit 11.

On the basis of the embodiments in FIG. 3 and FIG. 5, the method according to the invention is performed as follows:

The bottles 1 are brought into the optical inspection unit 18 by a transporter installation 19. As soon as a bottle is inside the optical inspection unit 18, various inspection steps are performed. The sequence of the inspection steps is arbitrary. For example, in the first step the lighting unit 11 is switched on as soon as the mouthpiece sealing surface 2 of the bottle 1 can be reasonably illuminated by the lighting unit 11, i.e. is positioned centrically. At this point of time, the mouthpiece camera 9 records an image of the mouthpiece sealing surface 2. Consequently, in this inspection step the outside area of the mouthpiece sealing surface is inspected. Subsequently the annular lighting unit is switched off and, for example, the lighting unit 12 is switched on. The lighting unit 12 directs its light onto the mouthpiece sealing surface, from a direction essentially perpendicular to the mouthpiece sealing surface. Now, camera 9 can record another image of the mouthpiece sealing surface 2. Since the lighting unit 11 is already switched off again at this point of time, the image recorded by camera 9 is of high contrast. By all means, the bottle 1 may have moved forward slightly between these first two inspection steps. This is not shown explicitly in FIG. 3 or 4, but can be seen clearly in FIG. 5 (distance V).

At a bottle speed of approximately 2 m per second, the bottle will have moved by 0.4 mm during the time of 200 microseconds (time interval between two recordings). This ensures that the bottle 1 does not leave the range of camera 9. Because the movement of the bottle is only slight, the image of the mouthpiece sealing surface can be expected to be sharp. If the bottles are spaced at approximately 10 cm, this speed corresponds to a throughput of 72,000 bottles per hour, which is sufficient for all common requirements.

After a certain time, the bottle 1 will have moved into position shown as bottle 1′. In this position, a bottom illuminating lamp 13 may now be switched on, and an image of the bottle bottom can be recorded by means of camera 9 (FIG. 3) or 10 (FIG. 4), which is focused on the bottom of the bottle. In the embodiment presented here, this image is recorded through the annular lighting unit 11 as well. After the camera 10 has recorded the image, the lighting unit 13 may be switched off again.

Consequently, in the embodiment of the invention presented here, it is possible to inspect both the inside and the outside of the mouthpiece sealing surface, as well as the bottle bottom, in a single inspection unit 18. In case of the assumed speed of 2 meters per second, the next bottle will reach the center of the annular lighting unit 11 50 microseconds after the previous bottle has left the center of the annular lighting unit 11. Within these 50 microseconds, all inspection steps for the evaluation of the bottle possible by means of optical methods may be completed.

The lighting units 11, 12, and 13 may be realized as flashlights, LED arrays, halogen lamps, ordinary incandescent bulbs, strobe lamps, fluorescent tubes, laser diodes or any other type of light source. The beam splitters 14, 15, or 16 may be made of semi-transparent glass plates, but also of prismatic glass bodies. The cameras 9 and 10 may be CCD cameras, for example, which can record and send out digitizable images in a very short time.

The images recorded with cameras 9 and 10 may subsequently be evaluated by means of an electronic evaluation installation 21 with regard to defective or dirty bottles.

After completion of the last inspection step with regard to a specific bottle, the bottle is taken out of the optical inspection unit 18 and, in the case of a defective or dirty bottle, eliminated directly afterwards by means of an ejection station 17.

The methods presented here are suitable for the optical inspection of bottles with a mouthpiece for a crown cork closure, a screw cap, wide-mouth bottles, as well as PET bottles with a carrying ring.

With the apparatus for the optical inspection of bottles according to the invention it is possible to design a short and compact inspection unit, which can shorten the overall machine length. The use of a single camera for recording multiple images is very advantageous with regard to cost factors.

1. Apparatus for the optical inspection of bottles (1) in an inspection station (18), comprising at least one camera (9, 10) for recording images of a bottle (1) or a bottle part (2, 5) and at least one lighting unit (11, 12, 13) which illuminates at least one bottle (1) or one bottle part (2, 5), characterized by the fact that installations for at least two inspection steps are provided in the inspection station (18) in such a manner that the inspection steps occur at different points of time following one another as closely as possible.

2. Apparatus for the optical inspection of bottles (1) according to claim 1, characterized by the fact that the installations for several inspection steps are such that the temporally last inspection step on a bottle (1) is completed before the first inspection step of the next bottle is started.

3. Apparatus for the optical inspection of bottles (1) according to claim 1 or 2, characterized by the fact that at least one camera (9) is provided for recording images of the mouthpiece sealing surface (2) of a bottle (1).

4. Apparatus for the optical inspection of bottles (1) according to one of the claims 1 to 3, characterized by the fact that one camera (10) is provided for recording images of the bottom (5) of the bottle.

5. Apparatus for the optical inspection of bottles (1) according to one of the claims 1 to 4, characterized by the fact that a lighting unit (13) is provided, which illuminates the bottle bottom (5) entirely or in part.

6. Apparatus for the optical inspection of bottles (1) according to one of the claims 1 to 5, characterized by the fact that an annular lighting unit (11) is provided, which illuminates the mouthpiece sealing surface (2) of a bottle, in particular radially from above at an angle.

7. Apparatus for the optical inspection of bottles (1) according to one of the claims 1 to 6, characterized by the fact that a lighting unit (12) is provided, which illuminates the area of the mouthpiece sealing surface (2) essentially perpendicularly.

8. Apparatus for the optical inspection of bottles (1) according to one of the claims 1 to 7, characterized by the fact that an installation (19) is provided, which moves the bottles relative to the inspection station (18).

9. Apparatus for the optical inspection of bottles (1) according to one of the claims 1 to 8, characterized by the fact that an installation (19) is provided, which moves the bottles continuously through the inspection station (18).

10. Apparatus for the optical inspection of bottles (1) according to one of the claims 1 to 9, characterized by the fact that an installation (15, 16) is, provided in such a manner that the light from at least two different positions is guided to a camera (9) so that the camera records images of bottles (1, 1′) or bottle parts (2) in various positions of the apparatus for the optical inspection (18).

11. Apparatus for the optical inspection of bottles (1) according to claim 10, characterized by the fact that the installation for guiding light comprises at least one beam splitter (15, 16).

12. Apparatus for the optical inspection of bottles (1) according to one of the claims 1 to 11, characterized by the fact that at least two different positions for inspection steps are arranged in such a manner that the bottles (1) or bottle parts (2, 5) to be inspected do not leave the range of the camera (9) and/or the vertical projection of an annular lighting unit (11).

13. Apparatus for the optical inspection of bottles (1) according to one of the claims 1 to 12, characterized by the fact that one or two cameras (9, 10) are provided in such a manner that at least two images of a bottle (1) and/or a bottle part (2, 5) are recorded, whereby the beam path from the bottle (1) and/or the bottle part (2, 5) to the camera (9, 10) or the cameras (9, 10) passes through an annular lighting unit (11) illuminating the mouthpiece sealing surface (2).

14. Method for the optical inspection of bottles, comprising the following steps:
bringing a bottle (1) into the inspection unit (18),
at least two inspection steps, following each other as close as possible, of at least one bottle (1) in the inspection unit (18),
taking the bottle out of the optical inspection unit (18).

15. Method for the optical inspection of bottles according to claim 14, characterized by the fact that the evaluation of a bottle (1) regarding its fitness for further use by means of optical methods is fully completed before the evaluation of another bottle (1) is started.

16. Method for the optical inspection of bottles (1) according to claim 14 or 15, characterized by the fact that the mouthpiece sealing surface (2) is inspected.

17. Method for the optical inspection of bottles according to one of the claims 14 to 16, characterized by the fact that the inside and/or outside of the mouthpiece sealing surface (2) is inspected.

18. Method for the optical inspection of bottles according to one of the claims 14 to 17, characterized by the fact that the bottom (5) of a bottle is inspected.

19. Method for the optical inspection of bottles according to one of the claims 14 to 18, characterized by the fact that the bottom (5) of a bottle is illuminated entirely or in part.

20. Method for the optical inspection of bottles according to one of the claims 14 to 19, characterized by the fact that the mouthpiece sealing surface (2) is illuminated by means of an annular lighting unit (11).

21. Method for the optical inspection of bottles according to one of the claims 14 to 20, characterized by the fact that the mouthpiece sealing surface (2) is illuminated from a direction essentially perpendicular to the mouthpiece sealing surface (2).

22. Method for the optical inspection of bottles according to one of the claims 14 to 21, characterized by the fact that a bottle (1) or a bottle part (2) is consecutively illuminated by two different lighting units (11, 12).

23. Method for the optical inspection of bottles according to one of the claims 14 to 22, characterized by the fact that one camera (9) records at least two images of one and the same bottle (1) or one and the same bottle part (2) with at least two different illuminations.

24. Method for the optical inspection of bottles according to one of the claims 14 to 23, characterized by the fact that at least two cameras (9, 10) records at least two images of one and the same bottle (1) or one and the same bottle part (2) with different illuminations.

25. Method for the optical inspection of bottles according to one of the claims 14 to 24, characterized by the fact that two different inspection steps are performed within a time interval of no more than 50 milliseconds.

26. Method for the optical inspection of bottles according to one of the claims 14 to 25, characterized by the fact that the bottles (1) are moved relative to the optical inspection unit (18).

27. Method for the optical inspection of bottles according to one of the claims 14 to 26, characterized by the fact that the bottles (1) are moved through the optical inspection unit (18) continuously.

28. Method for the optical inspection of bottles according to one of the claims 14 to 27, characterized by the fact that the camera (9) records at least two images of one and the same bottle (1) or one and the same bottle part (2) in different positions of the bottle which are spatially as close as possible to one another within the optical inspection unit (18).
